(19) United States
(12) Patent Application Publication
(10) Pub. No.: US 2013/0141400 A1
(43) Pub. Date: Jun. 6, 2013

(54) STYLUS

(71) Applicants: Yi-An Chen, Taipei City (TW); Ming-Fang Hsu, Taipei City (TW); Hung-Chang Hung, Taipei City (TW)

(72) Inventors: Yi-An Chen, Taipei City (TW); Ming-Fang Hsu, Taipei City (TW); Hung-Chang Hung, Taipei City (TW)

(21) Appl. No.: 13/678,562

(22) Filed: Nov. 16, 2012

(30) Foreign Application Priority Data
Dec. 2, 2011 (TW) 100144396

(51) Int. Cl. G06F 3/033

(52) U.S. Cl. CPC G06F 3/033
USPC 345/179

(57) ABSTRACT

A stylus including a shaft, an elastic cover, a tip base and an elastic element is provided. The shaft includes a groove and an end portion. The groove connects to the end portion. The elastic cover is disposed on the end portion and covers the groove. The tip base includes a head part and a neck part. A gap is formed between the head part and the elastic cover. The neck is disposed in the groove and is suitable for moving within the groove. When the tip base receives pressure, the tip base moves relative to the shaft, and presses the elastic element to move within the groove.

### CROSS-REFERENCE TO RELATED APPLICATION

This application claims the priority benefit of Taiwan application serial no. 100144396, filed on Dec. 2, 2011. The entirety of the above-mentioned patent application is hereby incorporated by reference herein and made a part of this specification.

### BACKGROUND OF THE INVENTION

1. Field of the Invention

The invention relates a stylus, and more particularly, to a stylus adapted for a touch panel.

2. Description of Related Art

With the rapid development of technology, most electronic devices, such as Tablet PCs, smart phones, or notebook computers usually have touch panels serving as input interfaces. The touch panels are generally classified into capacitive, resistive, infrared, and ultrasonic touch panels, wherein the resistive touch panels and the capacitive touch panels are the most common products.

The capacitive touch panels are operated by approaching or touching the touch panels with a finger or a stylus to change capacitances of the touch panels. While variations in the capacitances are detected, the location approached or touched by the finger or the stylus is determined, and an operation corresponding to the approached or touched location is performed. The capacitive touch panels have a multi-touch feature, which allows a more user-friendly operation mode. Therefore, the capacitive touch panels are gradually favored by the market.

Styluses with a smaller tip have an easier time tapping a smaller icon on a touch panel when compared to a finger. However, when writing on a touch panel with a stylus, the stylus can only provide a single type of brushstroke with a single thickness. Thus, if the thickness needs to be changed, it is achieved through a software function. However, after increasing or decreasing the thickness of the brushstroke through a software function, the stylus can still only provide a brushstroke with a single thickness.

### SUMMARY OF THE INVENTION

The invention provides a stylus that can change a thickness of a brushstroke when writing on a touch panel.

The invention provides a stylus, including a shaft, an elastic cover, a tip base, and an elastic element. The shaft includes a groove and an end portion. The groove connects to the end portion. The elastic cover is disposed on the end portion and covers the groove. The tip base includes a head part and a neck part. A gap is formed between the head part and the elastic cover. The neck is disposed in the groove and is suitable for moving within to groove. When the tip base of the stylus receives pressure, the tip base moves relative to the shaft, and presses the elastic element to move within the groove.

Based on the above, when the user uses the stylus of the invention to make contact with a touch panel, with the assistance of the tip base and the elastic element, the contact area of the elastic cover of the stylus towards the touch panel can be adjusted. This way, the thickness of the brushstroke written on the touch panel through the stylus can change according to user requirements, so as to change the brushstroke anytime through a simple and convenient method.

Several exemplary embodiments accompanied with figures are described in detail below to further describe the disclosure in details.

### BRIEF DESCRIPTION OF THE DRAWINGS

The accompanying drawings constituting a part of this specification are incorporated herein to provide a further understanding of the invention. Here, the drawings illustrate embodiments of the invention and, together with the description, serve to explain the principles of the invention.

FIG. 1A is a side view of a stylus according to an embodiment of the invention.

FIG. 1B is an enlarged cross-sectional view of the stylus in FIG. 1A along line I-I.

FIG. 2 is a cross-sectional view of the stylus of FIG. 1B perpendicularly in contact with a touch panel.

FIG. 3 is a cross-sectional view of the stylus of FIG. 1B non-perpendicularly in contact with a touch panel.

FIG. 4 is a partial enlarged cross-sectional view of a stylus according to another embodiment of the invention.

FIG. 5 is a partial enlarged cross-sectional view of a stylus according to another embodiment of the invention.

FIG. 6 is a partial enlarged cross-sectional view of a stylus according to another embodiment of the invention.

### DESCRIPTION OF EMBODIMENTS

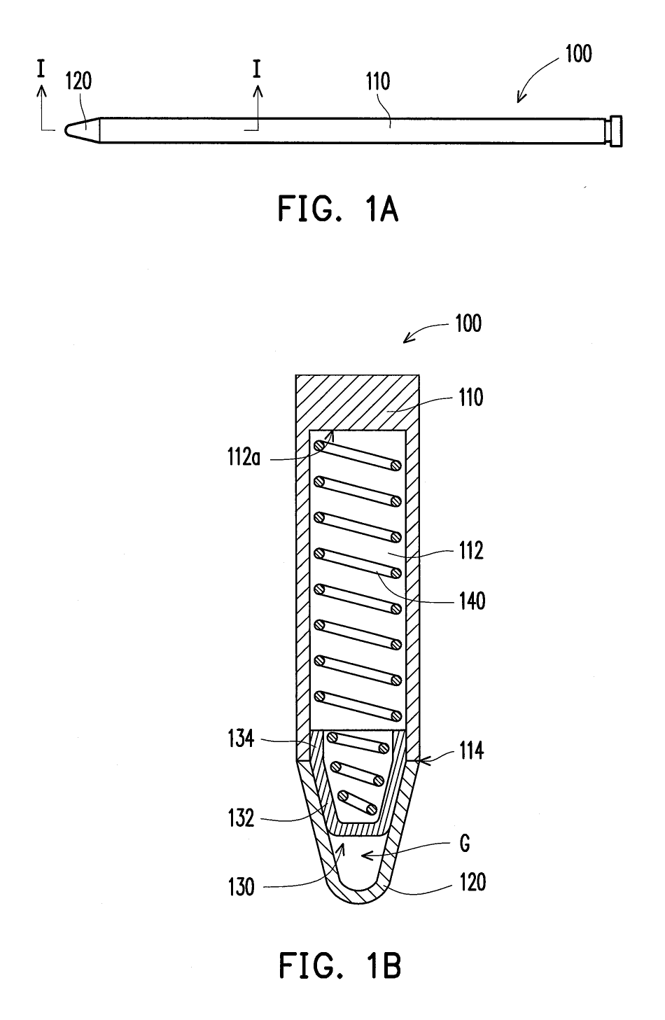

FIG. 1A is a side view of a stylus according to an embodiment of the invention. FIG. 1B is an enlarged cross-sectional view of the stylus in FIG. 1A along line I-I. Referring to FIGS. 1A and 1B, the stylus 100 of the embodiment is adapted to be used for a touch panel. The stylus 100 includes a shaft 110, an elastic cover 120, a tip base 130, and an elastic element 140. The shaft 110 includes a groove 112 and an end portion 114. The elastic cover 120 is disposed on the end portion 114 and covers the groove 112. The tip base 130 includes a head portion 132 and a neck portion 134. A gap G is formed between the head portion 132 and the elastic cover 120. The neck portion 134 is disposed in the groove 112 and is suitable for moving within the groove 112. The elastic element 140 is disposed in the groove 112, and elastically pushes the tip base 130 relative to the shaft 110.

In detail, the material of the shaft 110 and the elastic cover 120 can be conductive material. For example, the material of the shaft 110 can be metal, and the material of the elastic cover 120 can be conductive rubber. The head portion 132 of the tip base 130 can be cone shaped, so that the user has an easier time writing. In the embodiment, the elastic element 140 can be a helical spring, disposed in the groove 112. The elastic element 140 contacts the head portion 132 of the tip base 130. In general, the gap G between the head portion 132 and the elastic cover 120 can be between 0.5 mm and 1.5 mm, so as to give the stylus 100 suitable flexibility when writing.

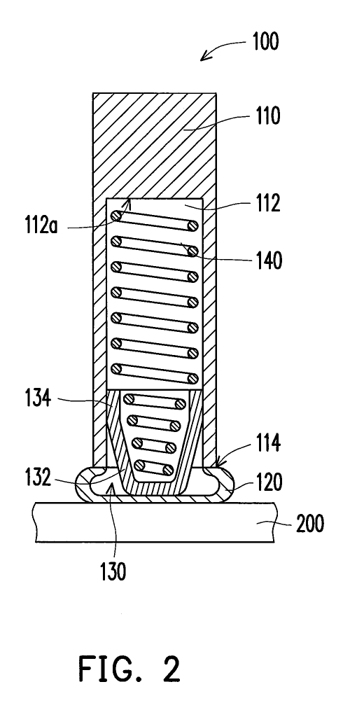

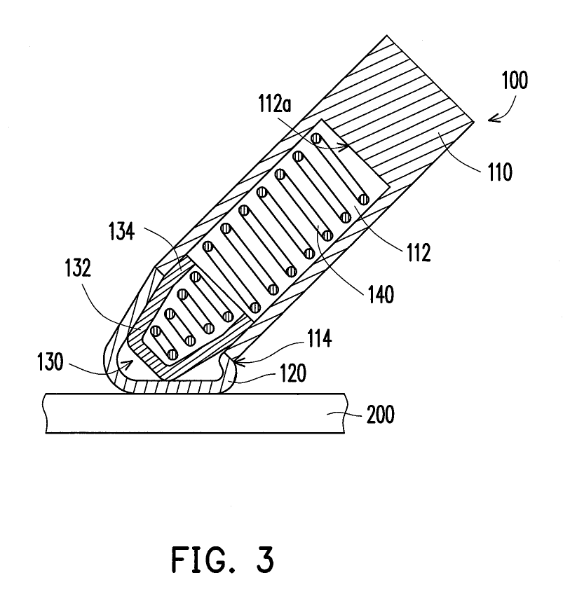

FIG. 2 is a cross-sectional view of the stylus of FIG. 1B perpendicularly in contact with a touch panel. FIG. 3 is a cross-sectional view of the stylus of FIG. 1B non-perpendicularly in contact with a touch panel. Referring to FIG. 2, when the user wants to use the stylus to operate the touch panel, the stylus 100 can contact the touch panel 200. When the user exerts force towards the touch panel 200, the tip base 130 moves towards a terminal 112a of the groove 112, and further pushes the elastic element 140. When the user uses the stylus 100 to write on the touch panel, the position of holding the stylus 100 is usually tilted relative to the touch panel 200 as seen in FIG. 3. Similarly, the head portion 134 of the stylus 100 moves relative to the terminal 112a of the groove 112 along a tilted axis of the shaft 110, and pushes the elastic element 140. Since the elastic cover 120 that covers the tip base 130 has elasticity, and a gap G is formed before any pressure is received between the tip base 130 and the elastic cover 120, when the elastic cover 120 receives a force and deforms, a contact area between the elastic cover 120 and a surface area 200 increases. This increases the operating success rate of the stylus 100. The contact area of the elastic cover 120 and the touch panel 200 can change with the force exerted by the user, and the thickness of the brushstroke changes accordingly. When the stylus 100 separates and does not contact with the touch panel 200, the head portion 132 and the elastic cover 120 no longer receives pressure, and the elastic element 140 pushes the head portion 132 back to the original position when receiving no pressure. Thus, the elastic cover 120 also recovers to its original form.

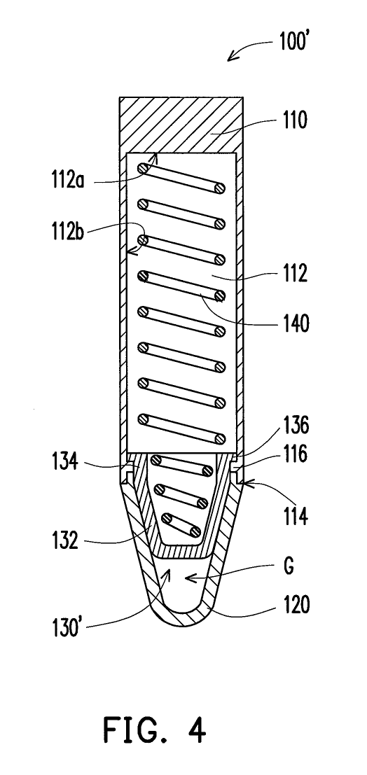

FIG. 4 is a partial enlarged cross-sectional view of a stylus according to another embodiment of the invention. Referring to FIG. 4, in a stylus 100′ of another embodiment of the invention, the shaft 110 further includes a stopper 116, protruding from a side 112b of the groove 112, and located on a moving path of the tip base 130′ relative to the shaft 110. The tip base 130′ includes at least one support portion 136. The support portion 136 corresponds to the stopper 116 and is adapted to lean against the stopper 116. With this configuration, the elastic element 140 contacting the tip base 130 can be blocked by the stopper 116, so as to apply a set pressure beforehand towards the elastic element 140. This way, when the user is writing, the reverse force generated towards the touch panel 200 when the elastic element 140 receives pressure is increased. As a result, the range of extension and retraction by the flexible element 140 is not too great, so that the tip base 130 is better used when writing.

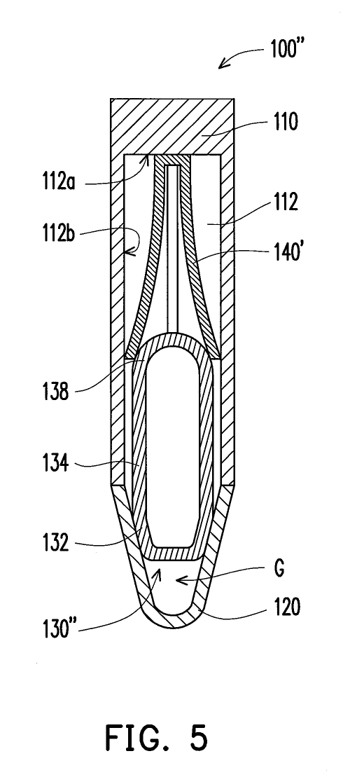

FIG. 5 is a partial enlarged cross-sectional view of a stylus according to another embodiment of the invention. Referring to FIG. 5, in a stylus 100″ of another embodiment of the invention, when compared to the stylus 100 of FIG. 1B, a flexible element 140′ further includes a plurality of wire springs, wherein an end of the flexible element 140′ is connected to and disposed in the groove 112. The tip base 130″ further includes a closed bottom portion 138. The other end of the flexible element 140′ (i.e. the wire springs) leans against the bottom portion 138 of the tip base 130.

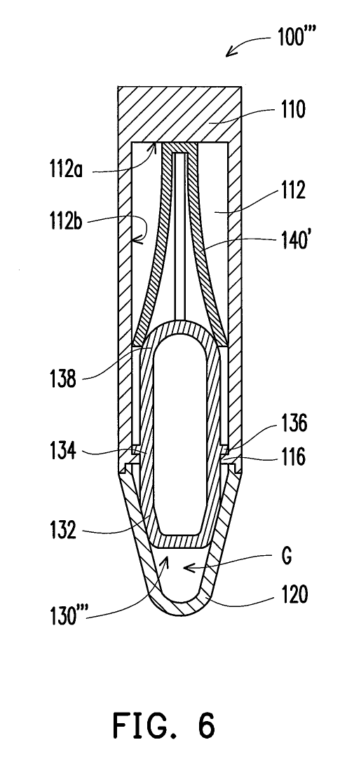

FIG. 6 is a partial enlarged cross-sectional view of a stylus according to another embodiment of the invention. Referring to FIG. 6, in a stylus 100″′ of another embodiment of the invention, compared to the stylus 100″ of the FIG. 5, the shaft 110 further includes a stopper 116, protruding from a side 112b of the groove 112, and located on a moving path of the tip base 130″′ relative to the shaft 110. The tip base 130″′ further includes at least one support portion 136. The support portion 136 corresponds to the stopper 116 and is adapted to lean against the stopper 116. The configuration of the embodiment is similar to the embodiment of FIG. 4, and is not repeated herein.

To sum up, when the user uses the stylus of the invention to make contact with a touch panel, with the assistance of the tip base and the elastic element, the contact area of the elastic cover of the stylus towards the touch panel can be adjusted. This way, the thickness of the brushstroke written on the touch panel through the stylus can change according to user requirements. In addition, the stopper of the shaft gives a suitable set pressure beforehand towards the elastic element. This way, the reverse force generated towards the touch panel when the elastic element receives pressure is increased. As a result, the range of movement of the tip base is not too great, so that the user can write more conveniently. Therefore, the invention has improved the functions and usage convenience of a stylus.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A stylus, comprising:
a shaft, including a groove and an end portion, wherein the groove connects to the end portion;
an elastic cover, disposed on the end portion and covering the groove;
a tip base, including a head portion and a neck portion, a gap being formed between the head portion and the elastic cover, wherein the neck portion is located in the groove and moves within the groove; and
a flexible element, disposed in the groove, wherein when the tip base receives a pressure, the tip base moves towards a terminal of the groove, and pushes the elastic element to move in the groove.

2. The stylus as claimed in claim 1, wherein the shaft further includes at least one stopper, and the stopper protrudes from the shaft and is located on a moving path of the tip base relative to the shaft.

3. The stylus as claimed in claim 1, wherein a material of the stylus and the elastic cover is a conductive material.

4. The stylus as claimed in claim 1, wherein a material of the shaft is metal.

5. The stylus as claimed in claim 1, wherein a material of the elastic cover is conductive rubber.

6. The stylus as claimed in claim 1, wherein a shape of the head portion is a cone shape.

7. The stylus as claimed in claim 1, wherein the elastic element is a helical spring.

8. The stylus as claimed in claim 1, wherein the elastic element includes a plurality of wire springs.

9. The stylus as claimed in claim 1, wherein the gap ranges between 0.5 mm and 1.5 mm.

10. The stylus as claimed in claim 2, wherein the tip base further includes a supporting portion, and the support portion is adapted to lean against the stopper.
